(19) United States
(12) Patent Application Publication
(10) Pub. No.: US 2007/0235603 A1
(43) Pub. Date: Oct. 11, 2007

(54) Frankenstand

(76) Inventor: Michael Ryan, San Diego, CA (US)

Correspondence Address: Michael Ryan, 997 Catalina, San Diego, CA, 92106, US

(21) Appl. No.: 11/726,341

(22) Filed: Mar. 21, 2007

Related U.S. Application Data
(60) Provisional application No. 60/785,609, filed on Mar. 23, 2006.

(51) Int. Cl. F16M 11/00

(52) U.S. Cl. 248/161

(57) ABSTRACT

A stand or tripod for receiving and holding objects, particularly speakers and/or accessories includes a hydraulic mechanism allowing the user to safely lower and raise the stand.

The main components, steps and materials used, shape, each component function, unique aspects are:
1. One Music industry standard six foot aluminum tripod speaker stand [aka Mobile Disc Jockey speaker stand], with locking devices and knobs.
2. One gas strut, approximately 4′ long, with two specific power strengths (190 and 280 newt) bolted in place with
3. Two “tamper proof” bolts through two holes drilled through the upper and lower center tube [aka pipe].
   1. How they work together:

The gas strut lifts the inner telescoping tripod pipe that the speaker is placed onto. The lifting action (neutral buoyancy) is similar to the action of a strut assisted automobile tailgate and/or engine bonnet or hood.

2. Alternative ways it can be made:

Instead of the “tripod” design, this system can be adapted by using two aluminum tubes, one inside of the other, with a locking device which doubles as a “bearing”, allowing the smooth operation of one tube inside of the other. The lower receiving tube fits into a female “adaptor” of a conical; disc shaped, metal base, approximately 24″ wide. A thin plastic cuplike cover is placed on the end of the inner telescoping tube to offset the space taken by the locking devise when the stand is in its expanded position.

### BACKGROUND OF INVENTION

1. Field of the Invention

The present invention relates to a stand or tripod for receiving and holding objects, particularly musical speakers and accessories. The stand or tripod includes a hydraulic gas “strut” inside it which helps the user to raise and lower the stand for ease in use.

2. Description of the Related Art

A stand of the above described type is known from Des 421,447 without the hydraulic gas strut. The stand is similar in appearance but cannot be raised or lowered as safely and as easily the Frankenstand.

### SUMMARY OF THE INVENTION

Therefore, it is the primary object of the present invention to provide a stand or tripod of the above-described type which is safer and easier to handle and operate, particularly with respect to raising or lowering the speaker on the stand.

Currently speaker stands are approximately 4′ and can be raised to 6′ to 7′ in height, requiring the operator to lift the full weight of the speaker above their normal reach.

Given the fact that a speaker may range in weight from 30 to 70 lbs., or more, this is not only clumsy, but can also be dangerous.

In accordance with the present invention, the hydraulic gas strut connected to the stand, allows the Frankenstand's height to be lowered to secure the speaker on the stand and then raised to the desired height by unlocking the braking system. This makes using the stand easier and safer to use and can be operated by one person alone.

The strut strength is matched by taking the average weight of numerous individual speakers. The strut's power, called “newts”, lifts the speaker to the closest point of “Neutral buoyancy”, making the speaker go up and down with a minimal of effort by the operator. Due to the strut's normal operation's constant effort to expand, a plastic sleeve “locking device” is attached to outside of the receiving pipe.

This adaptation is specific to speakers used by Mobile Disc Jockeys but could be used by bands and anyone needing to safely lift and lower speakers.

### BRIEF DESCRIPTION OF THE DRAWING

FIG. 1 is a front perspective view of a tripod showing where the gas strut is compressed and bolted inside the tripod.

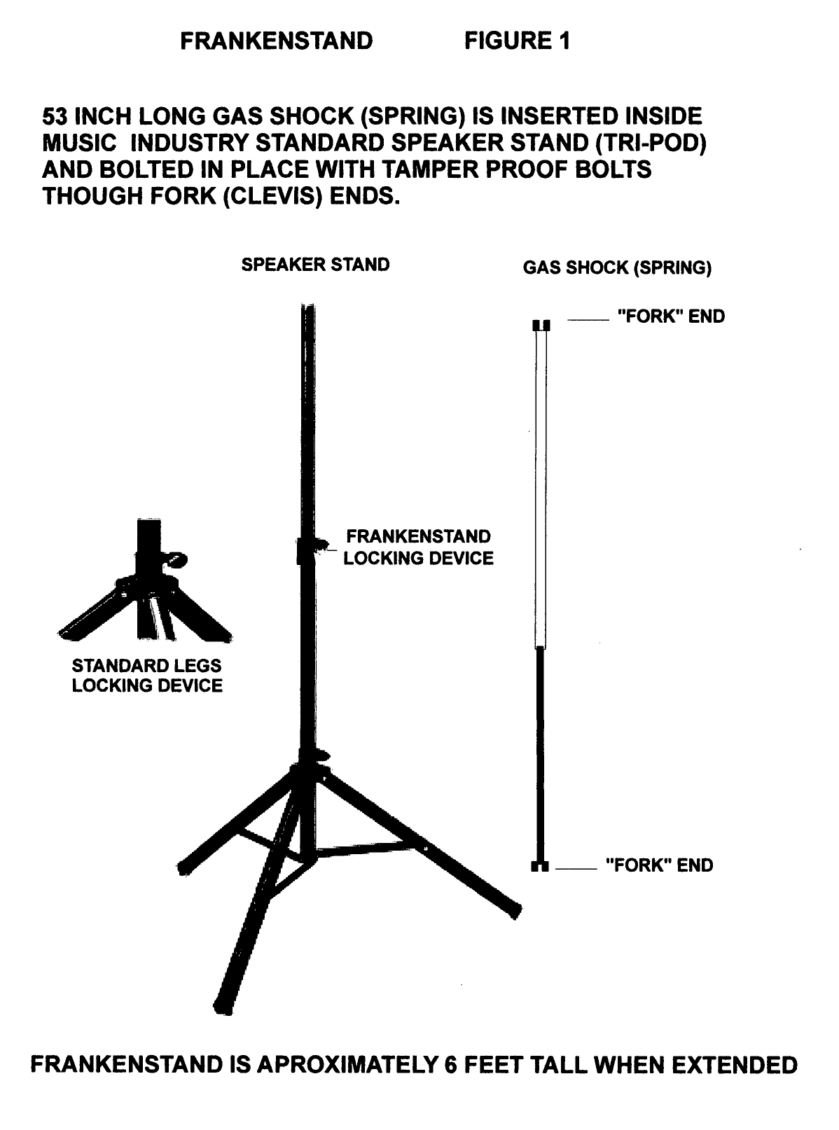

FIG. 1 is a view of the tri-pod legs locking device, speaker stand and gas strut fully extended.

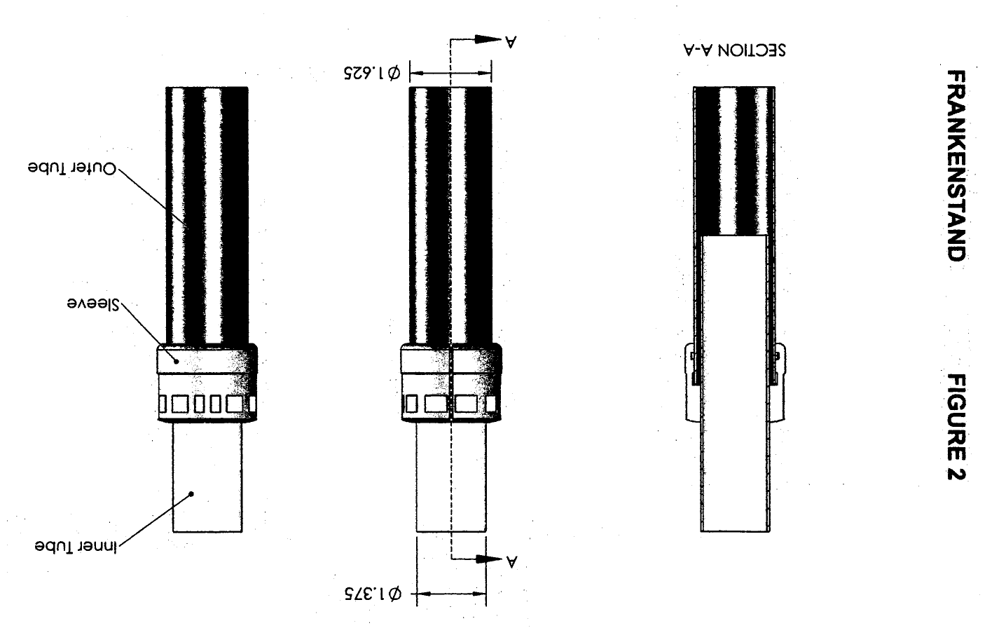

FIGS. 2 and 3 are views of the FRANKENSTAND LOCKING DEVICE.

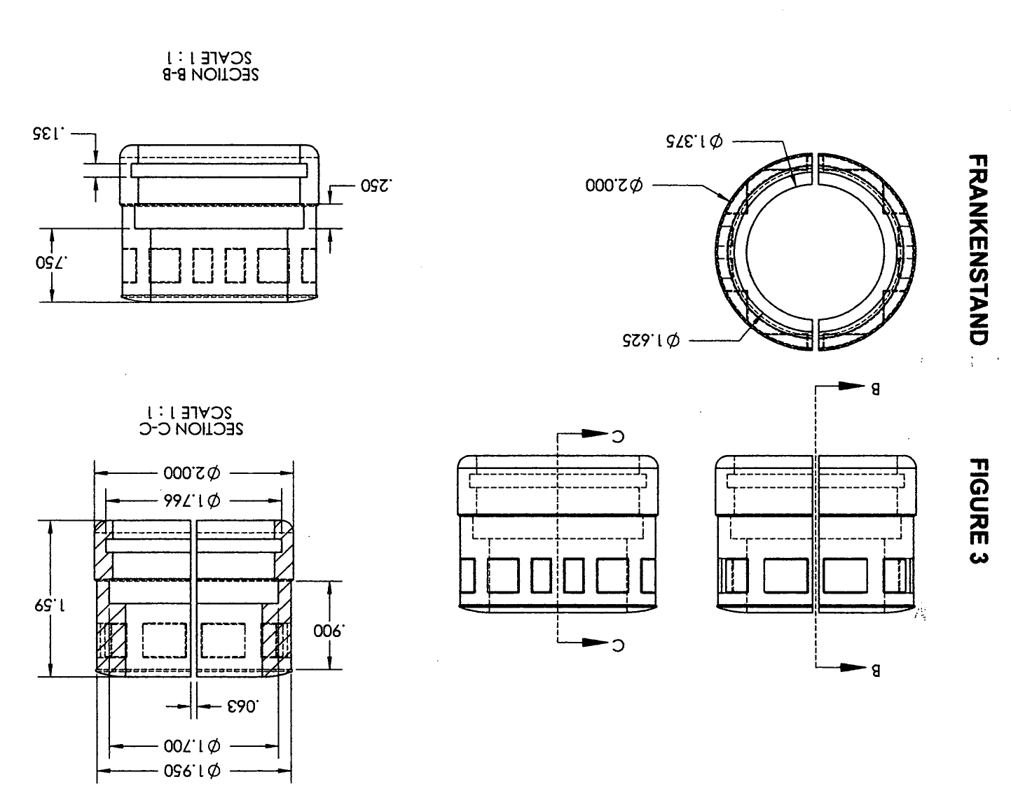

FIG. 4 is a view of the gas shock (aka spring, strut)

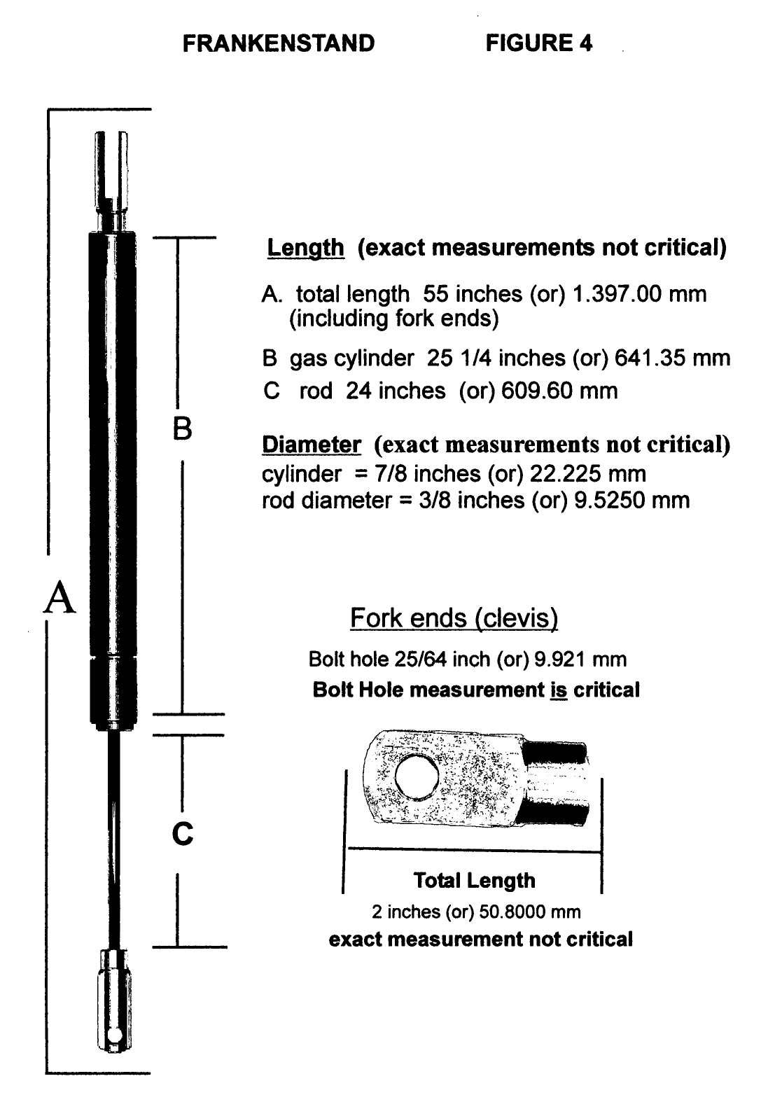

I claim:

1. A stand for receiving and holding objects, particularly speakers and accessories, the stand comprising of a hydraulic gas “shock” (aka spring, strut) inside of it allowing the stand to be easily lowered and raised.

2. The stand, according to claim 1, improves the current industry standard speaker stand on the market today in ease of operation and safety in usage.

3. By installing a hydraulic gas strut inside of the stand, according to claim 1, the stand's height can easily be lowered to secure the speaker on the stand and then raised to the desired height. This makes using the stand easier and safer and can be operated by one person alone.
